(19) United States
(12) Patent Application Publication
(10) Pub. No.: US 2023/0070132 A1
(43) Pub. Date: Mar. 9, 2023

(54) RESIN LENS WITH ENHANCED ANTI-BLUE LIGHT PERFORMANCE AND PREPARATION METHOD THEREOF

(71) Applicants: Jiangsu Conant Optical Co., Ltd., Nantong (CN); Shanghai Conant Optical Co., Ltd., Shanghai (CN)

(72) Inventors: Chuanbao WANG, Nantong (CN); Qingbo YAN, Nantong (CN); Jian HUANG, Nantong (CN); Yang LI, Nantong (CN); Liangliang SHI, Nantong (CN)

(21) Appl. No.: 17/647,264

(22) Filed: Jan. 6, 2022

Related U.S. Application Data
(63) Continuation of application No. PCT/CN2021/116153, filed on Sep. 2, 2021.

(30) Foreign Application Priority Data
Aug. 30, 2021 (CN) 202111007389.9

(51) Int. Cl. G02B 1/04; C08K 5/07; C08L 33/08

(52) U.S. Cl. CPC G02B 1/041; C08K 5/07; C08L 33/08

(57) ABSTRACT

A resin lens with enhanced anti-blue light performance and a preparation method thereof. Light transmittance of the lens at 415 nm is lower than 1%, light transmittance at 420 nm is 1.0-5.0%, light transmittance at 425 nm is 15-25%, blue light transmittance at 380-500 nm is 20-30%, visible light transmittance is greater than 88%, and a refractive index of the lens is 1.50, 1.56, 1.60, 1.67 or 1.74.

### CROSS REFERENCES

This application is the U.S. continuation application of International Application No. PCT/CN2021/116153 filed on 2 Sep. 2021 which designated the U.S. and claims priority to Chinese Application No. CN202 11007389,9 filed on 30 Aug. 2021, the entire contents of each of which are hereby incorporated by reference.

### TECHNICAL FIELD

The present invention belongs to the field of resin lenses, and specifically relates to a resin lens with enhanced anti-blue light performance and a preparation method thereof.

### BACKGROUND

Blue light refers to light with a wavelength of 380-500 nm. As a visible light, the blue light is short in wave length and high in energy and can directly penetrate a crystalline lens and reach the fundus retina. The short-wave blue light with a wavelength of 440-470 nm is the most harmful to the retina. What harm does the blue light have to the human body? 1. Excessive blue light or long-term exposure to the blue light can cause blurred vision, resulting in visual fatigue and VDT syndromes. 2. Excessive blue light or long-term exposure to the blue light can cause diminution of vision or even complete vision loss. 3. The blue light directly reaches the retina, which can cause age-related macular degeneration, glaucoma, and cataracts. 4. The blue light stimulates production of melanin, resulting in uneven skin tone, chloasma and freckles. 5. The blue light inhibits secretion of melatonin, and destroys the balance of human hormones. As a result, human immunity is reduced, sleep quality is seriously affected, work efficiency is reduced, and major diseases such as depression, gallstones and cancer are caused.

In China, many students have myopia at low ages, which seriously affects physical and mental health of children, and thus becomes a major issue concerning the future of the country and nations. Therefore, great attention needs to be paid to the myopia without allowing free development of the myopia. The whole society needs to take actions to take good care of children's eyes.

In 2019, in order to regulate standards of anti-blue light lenses on the market, GB/T38120-2019 entitled “Technical Requirements on Application of Light Health and Light Safety of Coating for Protection against Blue Light” has been issued in China. At present, there are many kinds of anti-blue light resin lenses on the market. Resin lenses with different refractive indexes have different anti-blue light effects. However, the overall anti-blue light effect is relatively poor. The resin lenses are only sold as hotspots on the market.

### SUMMARY

In view of the shortcomings above, an objective of the present invention is to provide a resin lens with enhanced anti-blue light performance (UV++plus) and a preparation method thereof. The anti-blue light performance of the lens can be enhanced within a full refractive index range of the lens.

In order to achieve the above objective, the present invention is implemented through the following technical solutions:

A resin lens with enhanced anti-blue light performance is provided. Light transmittance of the lens at 415 nm is lower than 1%, light transmittance at 420 nm is 4.5-5.5%, light transmittance at 425 nm is 18-22%, blue light transmittance at 380-500 nm is 20-30%, visible light transmittance is greater than 88%, and a refractive index of the lens is 1.50, 1.56, 1.60, 1.67 or 1.74.

Preferably, raw materials of the lens include a main raw material and an anti-blue light absorber, the main raw material includes a monomer and a reaction auxiliary, and the reaction auxiliary is an initiator or a catalyst. The anti-blue light absorber includes a methyl enoate anti-blue light absorber and further includes other anti-blue light absorbers, such as a benzophenone anti-blue light absorber or a benzotriazole anti-blue light absorber.

Preferably, the resin lens with enhanced anti-blue light performance with the refractive index of 1.50 includes diethylene glycol allyl carbonate and a polymer thereof as the monomer of the lens and 1,1-di-tert-butylperoxy-3,3,5-trimethylcyclohexane as the initiator;

the resin lens with enhanced anti-blue light performance with the refractive index of 1.56 comprises an unsaturated acrylate as the monomer of the lens and azodiisobutyronitrile as the initiator;

the resin lens with enhanced anti-blue light performance with the refractive index of 1.60 or 1.67 comprises a polyurethane raw material as the monomer of the lens and an organotin catalyst as the catalyst; and

the resin lens with enhanced anti-blue light performance with the refractive index of 1.74 comprises an episulfide compound or a polymercaptan compound as the monomer of the lens and an amine catalyst as the catalyst.

Preferably, in the resin lens with enhanced anti-blue light performance with the refractive index of 1.50, a mass ratio of the monomer to the initiator is 100:(2-5);

in the resin lens with enhanced anti-blue light performance with the refractive index of 1.56, a mass ratio of the monomer to the initiator is 100:(0.1-0.8);

in the resin lens with enhanced anti-blue light performance with the refractive index of 1.60, a mass ratio of the monomer to the catalyst is 100:(0.01-0.08);

in the resin lens with enhanced anti-blue light performance with the refractive index of 1.67, a mass ratio of the monomer to the catalyst is 100:(0.01-0.08);

in the resin lens with enhanced anti-blue light performance with the refractive index of 1.74, a mass ratio of the monomer to the catalyst is 100:(0.02-0.1).

Preferably, the methyl enoate anti-blue light absorber is methyl ethyl-2-cyano-3-(4-hydroxy-3-methoxyphenyl)-2-enoate;

in the resin lens with enhanced anti-blue light performance with the refractive index of 1.50, a use amount of the methyl enoate anti-blue light absorber is 0.5-5% of a mass of the monomer, preferably 1-3%; and

in the resin lens with enhanced anti-blue light performance with the refractive index of 1.56, 1.60, 1.67 or 1.74, a use amount of the methyl enoate anti-blue light absorber is 0.01-1% of a mass of the monomer, preferably 0.1-0.8%.

Preferably, in the raw materials of the resin lens with enhanced anti-blue light performance with the refractive index of 1.50, the anti-blue light absorber further includes a benzophenone anti-blue light absorber; and a use amount of the benzophenone anti-blue light absorber is 2-8% of the mass of the monomer, preferably 2.5-5%.

Preferably, in the raw materials of the resin lens with enhanced anti-blue light performance with the refractive index of 1.56, 1.60, 1.67 or 1.74, the anti-blue light absorber further includes a benzotriazole anti-blue light absorber; and a use amount of the benzotriazole anti-blue light absorber is 0.1-2% of the mass of the monomer, preferably 0.5-1.5%.

Preferably, the benzophenone anti-blue light absorber is any one or more of 2-hydroxy-4-methoxybenzophenone, 2-hydroxy-4-octyloxybenzophenone, 2,2′-dihydroxy-4,4′-dimethoxybenzophenone, 2,2′,4,4′-tetrahydroxy-benzophenone and 2,2′-hydroxy methoxybenzophenone; and

the benzotriazole anti-blue light absorber is one of 2-(2-hydroxy-3-tert-butyl methylphenyl)-5-chlorobenzotriazole, 2-(2′-hydroxy-3′,5′-ditert-butylphenyl) chlorobenzotriazole, 2-(2′-hydroxy-3′,5′-di-tert-butylphenyl)-5-chlorobenzotriazole, 2-(2′-hydroxy-3′,5′-di-tert-amylphenyl)benzotriazole and 2-(2′-hydroxy-5′-tert-octylphenyl)benzotriazole.

Preferably, in order to prevent the lens from being too yellow, the raw materials of the lens further include a blue-red complementary colorant, the blue-red complementary colorant used for the resin lens with enhanced anti-blue light performance with the refractive index of 1.50 is an inorganic dye, and an added amount of the inorganic dye is 0.01-0.5% of the mass of the monomer. The blue-red complementary colorant used for the resin lens with enhanced anti-blue light performance with the refractive index of 1.56, 1.60, 1.67 or 1.74 is an organic dye, and an added amount of the organic dye is 0.05-1% of the mass of the monomer.

A preparation method of the resin lens with enhanced anti-blue light performance includes the following steps:

dissolving the anti-blue light absorber and the catalyst or the initiator in the monomer, adding other additives, uniformly mixing and stirring at a certain temperature for 30-60 minutes, and then conducting standing under vacuum for 30-45 minutes;

filtering a material prepared above, and injecting the material into a mold for sealing;

after completely pouring the material into the mold, sequentially conducting primary curing and secondary curing; and

after the curing is completed, beveling and cleaning, and then conducting hardening and plating with a green film.

By using the method above, the other additives include a blue-red complementary colorant and a mold release agent.

By using the method above, the raw materials of the lens with the refractive index of 1.50 or 1.56 are stirred at a temperature of 20-40° C., and the raw materials of the lens with other refractive indexes are stirred at a temperature of 8-10° C.

Compared to the prior art, the present invention has the following beneficial effects:

According to the resin lens with enhanced anti-blue light performance prepared in the present invention, the anti-blue light performance of the lens can be enhanced within the full refractive index range of the lens. The light transmittance at 415 nm is lower than 1%, the light transmittance at 420 nm is about 5%, the light transmittance at 425 nm is about 20%, the blue light transmittance at 380-500 nm is 20-30%, the visible light transmittance is greater than 85%, and a yellow index is lower than 15%. In addition, requirements for the transmittance of the harmful blue light and beneficial blue light specified in the national standard GB/T 38120-2019 are met.

According to the present invention, a new methyl enoate anti-blue light absorber is developed and used in conjunction with existing anti-blue light absorbers. The anti-blue light performance is enhanced, and the visible light transmittance is ensured.

### DETAILED DESCRIPTION

Preferred embodiments of the present invention will be described in more detail below with reference to specific embodiments.

### Example 1

A resin lens with enhanced anti-blue light performance with a refractive index of 1.50 included the following raw materials: 100 kg of diethylene glycol allyl carbonate and a polymer thereof as a monomer, 3 kg of 1,1-di-tert-butylperoxy-3,3,5-trimethylcyclohexane as an initiator, 3 kg of 2-hydroxy-4-methoxybenzophenone and 1 kg of methyl ethyl-2-cyano-3-(4-hydroxy-3-methoxyphenyl)-2-enoate as an anti-blue light absorber, and 0.3 kg of an inorganic dye as a blue-red complementary colorant.

A preparation method of the resin lens included the following steps:

the anti-blue light absorber and the initiator were dissolved in the monomer, the inorganic dye and a mold release agent were added, uniformly mixed and stirred at 25° C. for 30-60 minutes, and then standing was conducted under vacuum for 30-45 minutes;

a material prepared in step (1) was filtered, injected into a mold, and sealed;

after the material was completely poured into the mold in step (2), primary curing and secondary curing were sequentially conducted; and

after the curing was completed, beveling and cleaning were conducted, and then hardening and plating with a green film were conducted.

### Example 2

A resin lens with enhanced anti-blue light performance with a refractive index of 1.56 included the following raw materials: 100 kg of an unsaturated acrylate as a monomer, 0.3 kg of azodiisobutyronitrile as an initiator, 1 kg of 2-(2-hydroxy-3-tert-butyl methylphenyl)-5-chlorobenzotriazole and 0.5 kg of methyl ethyl-2-cyano-3-(4-hydroxy-3-methoxyphenyl)-2-enoate as an anti-blue light absorber, and 0.5 kg of an organic dye as a blue-red complementary colorant.

A preparation method of the resin lens included the following steps:

the anti-blue light absorber and the initiator were dissolved in the monomer, the organic dye and a mold release agent were added, uniformly mixed and stirred at 30° C. for 30-60 minutes, and then standing was conducted under vacuum for 30-45 minutes;

a material prepared in step (1) was filtered, injected into a mold, and sealed;

after the material was completely poured into the mold in step (2), primary curing and secondary curing were sequentially conducted; and

after the curing was completed, beveling and cleaning were conducted, and then hardening and plating with a green film were conducted.

### Example 3

A resin lens with enhanced anti-blue light performance with a refractive index of 1.60 included the following raw materials: 100 kg of polyurethane as a monomer, 0.05 kg of an organotin catalyst, 0.8 kg of 2-(2′-hydroxy-3′,5′-ditert-butylphenyl) chlorobenzotriazole and 0.3 kg of methyl ethyl-2-cyano-3-(4-hydroxy methoxyphenyl)-2-enoate as an anti-blue light absorber, and 0.7 kg of an organic dye as a blue-red complementary colorant.

A preparation method of the resin lens included the following steps:

the anti-blue light absorber and the catalyst were dissolved in the monomer, the organic dye and a mold release agent were added, uniformly mixed and stirred at 8° C. for 30-60 minutes, and then standing was conducted under vacuum for 30-45 minutes;

a material prepared in step (1) was filtered, injected into a mold, and sealed;

after the material was completely poured into the mold in step (2), primary curing and secondary curing were sequentially conducted; and

after the curing was completed, beveling and cleaning were conducted, and then hardening and plating with a green film were conducted.

### Example 4

A resin lens with enhanced anti-blue light performance with a refractive index of 1.67 included the following raw materials: 100 kg of polyurethane as a monomer, 0.05 kg of an organotin catalyst, 1.2 kg of 2-(2′-hydroxy-3′,5′-ditert-butylphenyl)-5-chlorobenzotriazole and 0.6 kg of methyl ethyl-2-cyano-3-(4-hydroxy-3-methoxyphenyl)-2-enoate as an anti-blue light absorber, and 0.1 kg of an organic dye as a blue-red complementary colorant.

A preparation method of the resin lens included the following steps:

the anti-blue light absorber and the catalyst were dissolved in the monomer, the organic dye and a mold release agent were added, uniformly mixed and stirred at 10° C. for 30-60 minutes, and then standing was conducted under vacuum for 30-45 minutes;

a material prepared in step (1) was filtered, injected into a mold, and sealed;

after the material was completely poured into the mold in step (2), primary curing and secondary curing were sequentially conducted; and

after the curing was completed, beveling and cleaning were conducted, and then hardening and plating with a green film were conducted.

### Example 5

A resin lens with enhanced anti-blue light performance with a refractive index of 1.74 included the following raw materials: 100 kg of an episulfide compound as a monomer, 0.08 kg of an amine catalyst, 1 kg of 2-(2′-hydroxy-3′,5′-di-tert-butylphenyl)-5-chlorobenzotriazole and 0.2 kg of methyl ethyl-2-cyano-3-(4-hydroxy-3-methoxyphenyl)-2-enoate as an anti-blue light absorber, and 0.3 kg of an organic dye as a blue-red complementary colorant.

A preparation method of the resin lens included the following steps:

the anti-blue light absorber and the catalyst were dissolved in the monomer, the organic dye and a mold release agent were added, uniformly mixed and stirred at 10° C. for 30-60 minutes, and then standing was conducted under vacuum for 30-45 minutes;

a material prepared in step (1) was filtered, injected into a mold, and sealed;

after the material was completely poured into the mold in step (2), primary curing and secondary curing were sequentially conducted; and

after the curing was completed, beveling and cleaning were conducted, and then hardening and plating with a green film were conducted.

Optical properties of the resin lenses prepared in examples above were shown in Table 1.

TABLE 1
Optical properties of the resin lenses prepared in examples

| | | | | Blue light | |
|---|---|---|---|---|---|
| | Transmittance | Transmittance | Transmittance | transmittance | Visible light |
| Sample/item | at 415 nm | at 420 nm | at 425 nm | at 380-500 nm | transmittance |
| Example 1 | 0.25% | 1.62% | 15.22% | 20.28% | 90.52% |
| Example 2 | 0.34% | 2.98% | 20.83% | 25.64% | 95.63% |
| Example 3 | 0.60% | 3.75% | 23.38% | 27.33% | 94.04% |
| Example 4 | 0.29% | 2.28% | 18.64% | 23.64% | 92.12% |
| Example 5 | 0.32% | 4.65% | 22.75% | 24.78% | 93.39% |

According to data above, the resin lenses with enhanced anti-blue light performance prepared in examples of the present invention meet the requirements of Chinese standard, the anti-blue light performance of the lens is further enhanced, and the visible light transmittance is ensured.

The embodiments of the present invention are described above, and the foregoing descriptions are exemplary but not exhaustive and are not limited to the disclosed embodiments. Without departing from the scope and technical principles of the illustrated embodiments, it is obvious to a person of ordinary skill in the art that many modifications and changes will be made, and these modifications and changes should also be considered within the scope of protection of the present invention.

What is claimed is:

1. A resin lens with enhanced anti-blue light performance, wherein light transmittance of the lens at 415 nm is lower than 1%, light transmittance at 420 nm is 1.0-5.0%, light transmittance at 425 nm is 15-25%, blue light transmittance at 380-500 nm is 20-30%, visible light transmittance is greater than 88%, and a refractive index of the lens is 1.50, 1.56, 1.60, 1.67 or 1.74.

2. The resin lens with enhanced anti-blue light performance according to claim 1, wherein raw materials of a lens matrix comprise a main raw material and an anti-blue light absorber, the main raw material comprises a monomer and a reaction auxiliary, the reaction auxiliary is an initiator or a catalyst, and the anti-blue light absorber comprises a methyl enoate anti-blue light absorber.

3. The resin lens with enhanced anti-blue light performance according to claim 2, wherein
the resin lens with enhanced anti-blue light performance with the refractive index of 1.50 comprises diethylene glycol allyl carbonate and a polymer thereof as the monomer of the lens and 1,1-di-tert-butylperoxy-3,3,5-trimethylcyclohexane as the initiator;
the resin lens with enhanced anti-blue light performance with the refractive index of 1.56 comprises an unsaturated acrylate as the monomer of the lens and azodiisobutyronitrile as the initiator;
the resin lens with enhanced anti-blue light performance with the refractive index of 1.60 or 1.67 comprises a polyurethane raw material as the monomer of the lens and an organotin catalyst as the catalyst; and
the resin lens with enhanced anti-blue light performance with the refractive index of 1.74 comprises an episulfide compound or a polymercaptan compound as the monomer of the lens and an amine catalyst as the catalyst.

4. The resin lens with enhanced anti-blue light performance according to claim 3, wherein
in the resin lens with enhanced anti-blue light performance with the refractive index of 1.50, a mass ratio of the monomer to the initiator is 100:(2-5);
in the resin lens with enhanced anti-blue light performance with the refractive index of 1.56, a mass ratio of the monomer to the initiator is 100:(0.1-0.8);
in the resin lens with enhanced anti-blue light performance with the refractive index of 1.60, a mass ratio of the monomer to the catalyst is 100:(0.01-0.08);
in the resin lens with enhanced anti-blue light performance with the refractive index of 1.67, a mass ratio of the monomer to the catalyst is 100:(0.01-0.08);
in the resin lens with enhanced anti-blue light performance with the refractive index of 1.74, a mass ratio of the monomer to the catalyst is 100:(0.02-0.1).

5. The resin lens with enhanced anti-blue light performance according to claim 2, wherein
the methyl enoate anti-blue light absorber is methyl ethyl-2-cyano-3-(4-hydroxy methoxyphenyl)-2-enoate;
in the resin lens with enhanced anti-blue light performance with the refractive index of 1.50, a use amount of the methyl enoate anti-blue light absorber is 0.5-5% of a mass of the monomer, preferably 1-3%; and
in the resin lens with enhanced anti-blue light performance with the refractive index of 1.56, 1.60, 1.67 or 1.74, a use amount of the methyl enoate anti-blue light absorber is 0.01-1% of a mass of the monomer, preferably 0.1-0.8%.

6. The resin lens with enhanced anti-blue light performance according to claim 2, wherein
in the raw materials of the resin lens with enhanced anti-blue light performance with the refractive index of 1.50, the anti-blue light absorber further comprises a benzophenone anti-blue light absorber; and
in the raw materials of the resin lens with enhanced anti-blue light performance with the refractive index of 1.56, 1.60, 1.67 or 1.74, the anti-blue light absorber further comprises a benzotriazole anti-blue light absorber.

7. The resin lens with enhanced anti-blue light performance according to claim 6, wherein
in the resin lens with enhanced anti-blue light performance with the refractive index of 1.50, a use amount of the benzophenone anti-blue light absorber is 2-8% of the mass of the monomer, preferably 2.5-5%; and
in the resin lens with enhanced anti-blue light performance with the refractive index of 1.56, 1.60, 1.67 or 1.74, a use amount of the benzotriazole anti-blue light absorber is 0.1-2% of the mass of the monomer, preferably 0.5-1.5%.

8. The resin lens with enhanced anti-blue light performance according to claim 6, wherein
the benzophenone anti-blue light absorber is any one or more of 2-hydroxy-4-methoxybenzophenone, 2-hydroxy-4-octyloxybenzophenone, 2,2′-dihydroxy-4,4′-dimethoxybenzophenone, 2,2′,4,4′-tetrahydroxy-benzophenone and 2,2′-hydroxy-4-methoxybenzophenone; and
the benzotriazole anti-blue light absorber is one of 2-(2-hydroxy-3-tert-butyl-5-methylphenyl)-5-chlorobenzotriazole, 2-(2′-hydroxy-3′,5′-ditert-butylphenyl)-5-chlorobenzotriazole, 2-(2′-hydroxy-3′,5′-di-tert-butylphenyl)-5-chlorobenzotriazole, 2-(2′-hydroxy-3′,5′-di-tert-amylphenyl)benzotriazole and 2-(2′-hydroxy-5′-tert-octylphenyl)benzotriazole.

9. The resin lens with enhanced anti-blue light performance according to claim 2, wherein the raw materials of the lens matrix further comprise a blue-red complementary colorant, the blue-red complementary colorant used for the resin lens with enhanced anti-blue light performance with the refractive index of 1.50 is an inorganic dye, and an added amount of the inorganic dye is 0.01-0.5% of the mass of the monomer; and the blue-red complementary colorant used for the resin lens with enhanced anti-blue light performance with the refractive index of 1.56, 1.60, 1.67 or 1.74 is an organic dye, and an added amount of the organic dye is 0.05-1% of the mass of the monomer.

10. A preparation method of the resin lens with enhanced anti-blue light performance according to claim 1, comprising the following steps:
dissolving the anti-blue light absorber and the reaction auxiliary in the monomer, adding other additives, uniformly mixing and stirring at a certain temperature for 30-60 minutes, and then conducting standing under vacuum for 30-45 minutes;
filtering a material prepared above, and injecting the material into a mold for sealing;
after completely pouring the material into the mold, sequentially conducting primary curing and secondary curing; and
after the curing is completed, beveling and cleaning, and then conducting hardening and plating with a green film.
